(19) United States
(12) Patent Application Publication
(10) Pub. No.: US 2010/0328241 A1
(43) Pub. Date: Dec. 30, 2010

(54) METHOD AND SYSTEM FOR MEASURING POSITION ON SURFACE CAPACITANCE TOUCH PANEL USING A FLYING CAPACITOR

(76) Inventors: Keith Paulsen, Centerville, UT (US); Jared G. Bytheway, Sandy, UT (US)

Correspondence Address: MORRISS OBRYANT COMPAGNI, P.C., 734 EAST 200 SOUTH, SALT LAKE CITY, UT, 84102, US

(21) Appl. No.: 12/815,246

(22) Filed: Jun. 14, 2010

Related U.S. Application Data
(63) Continuation-in-part of application No. 12/719,717, filed on Mar. 8, 2010.
(60) Provisional application No. 61/186,794, filed on Jun. 12, 2009.

(51) Int. Cl. G06F 3/041

(52) U.S. Cl. 345/173

(57) ABSTRACT

A touch panel having a substantially even coating of a conductive material on a non-conductive substrate and then covering the conductive material with a dielectric material, wherein a novel current measuring circuit reduces the effect of stray capacitance on the accuracy of a current measurement so that the relative X and Y position of an object on the touch panel can be determined using simple ratio equations.

### CROSS REFERENCE TO RELATED APPLICATIONS

This document claims priority to and incorporates by reference all of the subject matter included in the provisional patent application docket number 4622.CIRQ.PR, having Ser. No. 61/186,794.

### BACKGROUND OF THE INVENTION

1. Field of the Invention

This invention relates generally to touchpad technology. More specifically, the present invention is a new method of determining the position of a pointing object on a surface capacitance touch panel.

2. Description of Related Art

A well-known touchpad technology uses a surface capacitance touch panel. Such a touch panel is a solid sheet of a conductive material disposed on an insulating substrate such as glass, with sensors disposed at the corners. The traditional method of measuring the position of a pointing object or the “touch position” on the surface capacitance touch panel is to apply an AC signal on all four corners of the touch panel's conductive layer. The conductive layer can be made, for example, of Indium Tin Oxide (ITO).

To create the touch panel, the surface of the glass substrate is flooded or covered with a substantially even layer of a resistive ITO material which forms a sheet resistance. A dielectric is then applied to cover the ITO conductive material.

After applying the AC signal to the conductive ITO material, the next step is to triangulate the touch position using the current flowing through each corner. It is common to apply either a sine wave or a square wave as the driving signal.

If an object such as a finger comes in contact with the surface of the touch panel, a capacitor is formed between the ITO surface and the finger tip. The capacitance value is very small, typically on the order of 50 pF. The amount of charge or current that has to be measured going into each corner of the panel is therefore very small. Because the current is small it is very susceptible to stray capacitance. Thus, the difficulty of making small measurements on touch panels that are free of stray capacitances is often an issue that challenges the accuracy of such devices.

Accordingly, what is needed is a new method of triangulating the position of the object on the touch panel surface that increases the accuracy of measurements and decreases susceptibility to stray capacitance.

### BRIEF SUMMARY OF THE INVENTION

It is an object of the present invention to provide a touch panel that uses a new method to determine a position of an object touching the surface thereof.

It is another object to provide a new method of measuring current that is less susceptible to stray capacitance.

In a first embodiment, the present invention is a touch panel having a substantially even coating of a conductive material on a non-conductive substrate, and then covering the conductive material with a dielectric material, wherein a novel current measuring circuit reduces the effect of stray capacitance on the accuracy of a current measurement so that the relative X and Y position of an object on the touch panel can be determined using simple ratio equations.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a touch panel as found in the prior art.

FIG. 2 is a perspective view of a touch panel 10 that is made in accordance with principles of the prior art.

FIG. 3 is a perspective view of a touch panel 10 that is made in accordance with the principles of the present invention.

FIG. 4 is a circuit diagram showing how a sensitive current measuring circuit comprised of a capacitor and a current measuring sensor is applied to the touch panel.

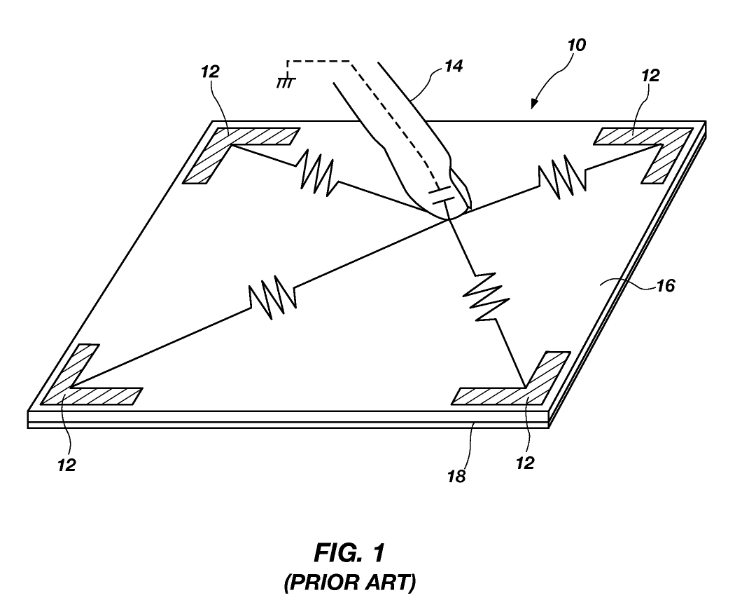

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

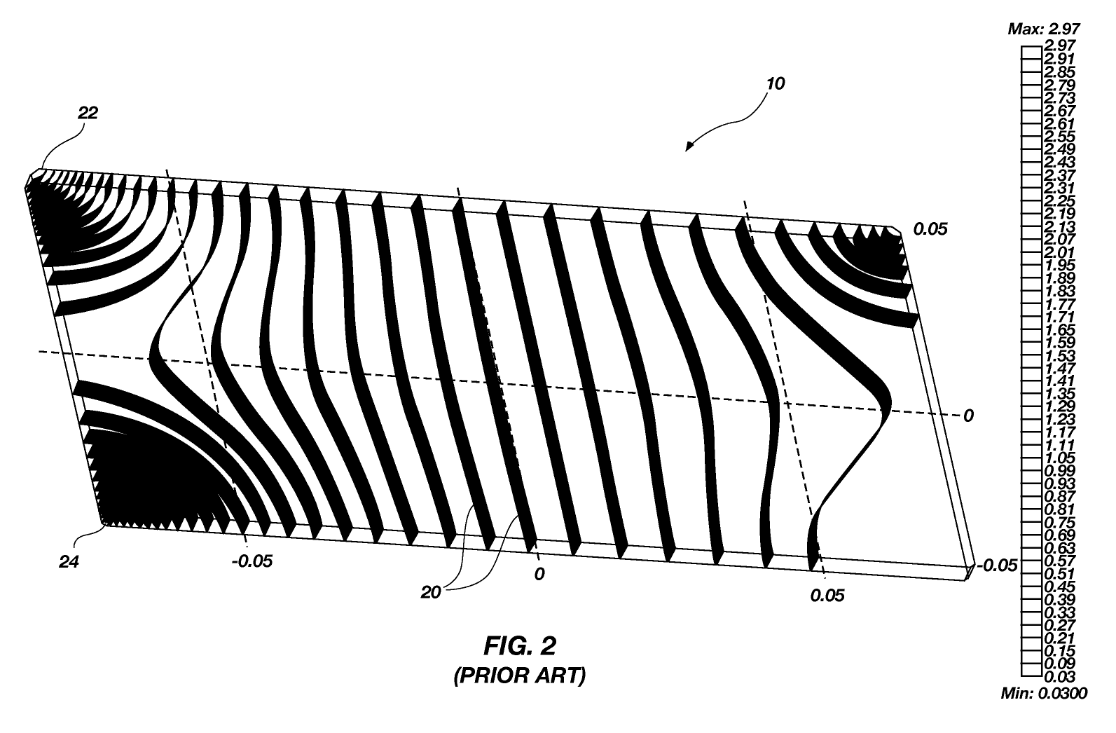

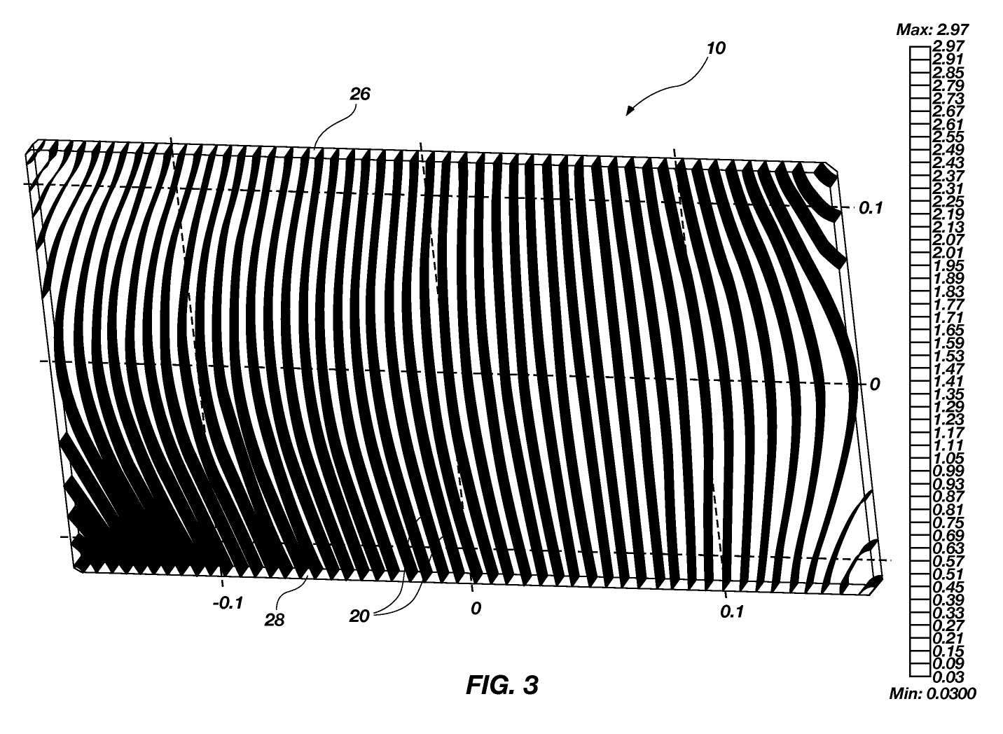

FIG. 2 shows the surface of a touch panel 10 as found in the prior art. The lines 20 are indicative of the voltage gradient that is produced across the surface of the touch panel when a voltage is applied at two corners of the surface. For example, the voltage is applied at corners 22 and 24 resulting in the constant voltage gradient shown. There is significant distortion of the voltage gradient lines 20 which is common to many touch panels 10.

FIG. 3 is a perspective view of a touch panel 10 that is made in accordance with the principles of the present invention. A new and novel approach to determining the position of an object on the touch panel is to charge a large capacitor and then apply this “flying capacitor” to the touch panel 10. In the flying capacitor method of the present invention, this method measures the instantaneous and total current induced in a contact on a surface of the touch panel 10 when a constant voltage gradient is produced across the surface in a single axis.

Linearity of a voltage gradient can improve accuracy of the touch panel. Therefore, in a first step, it is desirable but not essential that a lower resistance material be added around the edges of the touch panel 10 on the surface. The voltage gradient lines 20 become closer and more linear from a top edge 26 to a bottom edge 28.

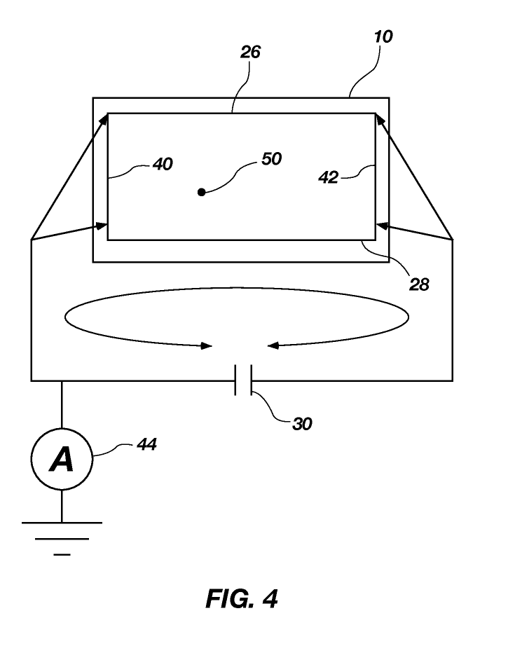

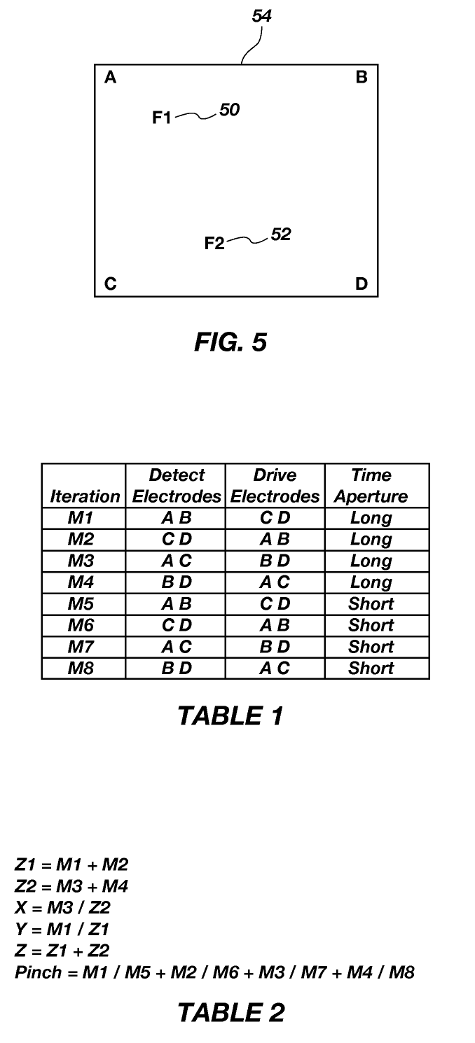

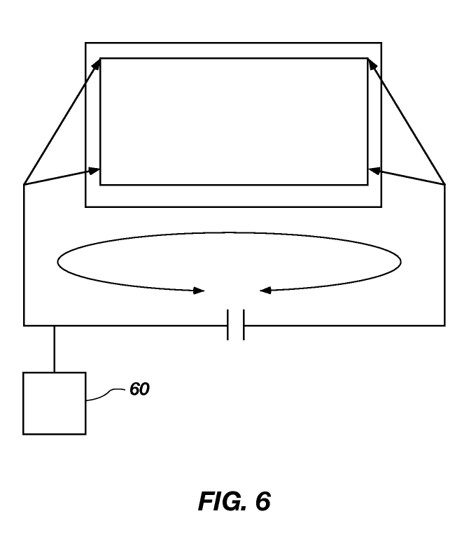

FIG. 4 is a circuit diagram showing how a sensitive current measuring circuit comprised of a capacitor and a current measuring sensor is applied to the touch panel 10 in a first embodiment of the present invention. Any charge that is taken from the touch panel 10 is measured with the current measuring circuit.

In this embodiment, four measurements X1, X2, X3 and X4 must be taken in order to determine the location of a pointing object 50 (located arbitrarily on the touch panel 10) on the surface of the touch panel 10. Therefore, the first step is to electrically couple a positive node of the flying capacitor 30 to a first side 40 of the touch panel 10 while the negative node is electrically coupled to an opposite second side 42 of the touch panel along with a sensor or current measuring circuit 44. The current measuring circuit 44 can be an ammeter.

The voltage gradient is formed across the surface of the touch panel 10 from the first side 40 to the second side 42, and to the sensor circuit 44. A finger or other pointing object 50 touching the surface of the touch panel 10 at any given point will cause a drain on the current that is being measured by the sensor circuit 44. The drain in current to the sensor circuit 44 is a function of the distance of the finger from the first and second sides 40, 42 of the touch panel 10. The first measurement X1 is thus the current leaving the touch panel 10 at the second side 44.

Assume that the first side 40 is arbitrarily a left side of the touch panel 10 as shown in FIG. 4. The second side 42 would therefore correspond to the right side of the touch panel 10. The first and second sides 40, 42 are arbitrarily selected and can be switched with no change in the method of the present invention.

The second current measurement X2 is taken by switching the positive and negative nodes of the flying capacitor 30 between the first and second sides 40, 42 of the touch panel 10. The current measuring circuit 44 is also moved when the circuit is reversed to take current measurement X2.

A position of the pointing object 50 can be determined as a ratio of current measurements X1 and X2. The position of the pointing object 50 is a value that is easily assigned to be between zero and one, and is determined using equation 1:

X=X1/(X1+x2)

Two similar measurements are taken using the top 26 and bottom 28 or third and fourth sides of the touch panel 10. The positive node of the flying capacitor 30 can be coupled to the top edge 26 or the bottom edge 28 first. The decision regarding which edge to connect to the positive node first is arbitrary. The result is current measurements Y1 and Y2. A Y position ratio is then obtained using equation 2:

Y+Y1/(Y1+Y2)

The strength of the present invention as described above is that the flying capacitor 30 is used to create the high current required to produce the constant voltage gradient on the surface of the touch panel 10 and thus enable direct measurement of the current leaving the surface though contacts on the surface. The current induced in the low resistance material is much larger than the current induced in the pointing object on the surface. Having a large current to measure increases the accuracy of the system and reduces the effect that stray capacitances can have on the measurements.

It should be understood that the charge on the flying capacitor 30 is rapidly being refreshed in order to maintain the voltage gradient across the touch panel 10. The process of disconnecting the flying capacitor 30 from the touch panel 10, refreshing the charge, and then reconnecting the flying capacitor to the touch panel 10 is well known to those skilled in the art and is not an aspect of the present invention.

It is also possible to determine a Z position of the pointing object relative to the surface of the touch panel 10. The Z location of the pointing object is determined using equation 3:

Z=(X1+X2+Y1+Y2)/4

The advantage of the embodiment of the present invention described above is that a voltage gradient is formed across the touch panel 10 using a relatively crude yet simple current measuring circuit 44. Nevertheless, a measurement of the current going to the pointing object is very precisely measured because there is no other path for the current to follow other than between the positive and negative nodes of the flying capacitor 30 and the pointing object 50.

An improvement to the measuring system described above will be referred to as the “bow-tie” method. In the method above, the method places a linear voltage across the touch panel in both the vertical and the horizontal directions, not just in one direction. For example, 0.4 V is disposed from a top right corner to a bottom right corner. This is a voltage gradient from one side to the other that should be linear.

In the prior art, one side is grounded. This method does not ground either side, but instead only requires a voltage difference across the touchpanel of 0.4 V. The next step is to measure the current that is induced in a finger by creating that voltage gradient. Thus, one side of the panel is quickly pulled up in voltage until the potential difference is 0.4 V. What the method measures is the current that passes through the finger of the user to ground. The amount of current is very small, typically on the order of femto amps. In contrast, the current across the touchpanel is on the order of milliamps. In the present example, approximately 4 milliamps is moving across the touchpanel.

Instead of using a power supply to provide the current, a capacitor (the “flying cap”) is used to supply the voltage and produce the current across the touchpanel. The effect of the capacitor is to eliminate the current in the loop across the touchpanel. Thus, the only current that leaves is the current that is leaving the circuit through the user's finger.

In one aspect of the present, the circuit is coupled to a sensor or measurement circuit to measure the current. Specifically, a Sense P line of a CIRQUE® touchpad sensor circuit is capable of measuring very small amounts of current. So even though large currents are being driven across the touchpanel, the sensor circuit is able to measure the very small amount of current that is being lost through the user's finger on the touchpanel.

The capacitor is charged to 0.4 V by connecting it to a power supply during a portion of the operational phase of a multiplexor. Then the multiplexor applies the voltage of the capacitor to the touchpanel.

There are several unique features of the method of this new embodiment. First, a method of using a switching power supply was adapted to charging the capacitor and then applying the charge on the capacitor to the touchpanel.

Second, the system effectively eliminates the current moving through the low resistance path of the touchpanel by using a capacitor to apply the voltage. In addition, the ability of the CIRQUE® sensor circuit to measure very small amounts of current flow enables the system to measure the small amount of current that leaves the system through the user's finger.

It is noted that the capacitor is charged approximately 350,000 times per second. All of the figures above should be understood to only be an example of the concepts of the present invention and should not be considered as limiting factors of the claims which follow.

The difficulty of the 8-wire method is in applying the method above to the problem of detecting and locating multiple fingers. The issue is how to use the system to determine where a finger is located when the location appears to be hidden due to superposition. A simple observation to be made is that each finger lies at a different distance from at least one edge of the touchpanel. Therefore, for at least one edge of the touchpanel, the resistance of the touchpanel that lies between a finger and that edge of the touchpanel will be different than the amount of resistance that lies between a different finger and that edge of the touchpanel.

FIG. 5 is an illustration of this situation. Finger 1 is at position 50, and finger 2 is at position 52. The resistance of the touchpanel from finger 1 to edge 54 and the resistance from finger 2 to edge 56 can now be determined using the CIRQUE® sensor circuit. Because of the difficulties inherent in such a measurement, it has not been done before.

It can be useful to only determine how far apart the fingers are from each other and not the location of the fingers. The distance between the fingers 50, 52 can be determined by the resistance between the fingers and edges of the touchpanel, where R is defined as the resistance of an edge of the touchpanel to the two fingers.

If the value of R is small, then the fingers are far apart. R is small because the fingers are both nearer to the edges of the touchpanel. An object nearer to the edges has a smaller resistance between itself and the edge. But if the fingers are close together, R will be larger, because at least or both of the fingers are far from the edges of the touchpanel. This means that we can determine if the fingers are pinched together and close to each other, or spread apart and unpinched.

Another way to state this relationship is to say that the value of R is related to the value of a Zoom feature. The resistance is therefore proportional to how far apart the fingers are located.

Another application of this method can be used to analyze a rotation gesture. The change of R in the X axis over the change of R in the Y axis. Using this method we can't determine which direction we are turning, but we can determine that the fingers are rotating.

Looking at Table 1, we see a chart where eight measurements are being made. There are actually only four different measurements being made, but one set of measurements uses a long time aperture and one set uses a short time aperture. The Detect Electrodes are those electrodes where the voltage is going down, and the Drive Electrodes are those electrodes where the voltage is being driven high to create the desired voltage gradient. The Sense P measurement line of the CIRQUE® sensor circuit 60 shown in FIG. 6 is coupled like an ammeter to the Detect Electrodes. We are then able to obtain the centroid using the calculations shown in Table 2.

The next step is determining the value of R. The charge on the capacitor is dissipating according to a curve. Tau equals 1/RC. The charge is dissipating according to e to t/tau. The CIRQUE® sensor circuit 60 does the integration required in our calculations. By determining two points on the curve and integrating, we can then determine the value of R. Thus, eight complete measurements are required to determine a single point.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for determining the distance between two fingers on a touchpanel, said method comprising the steps of:
1) providing a touch panel comprised of an insulating substrate, a resistive material disposed on the substrate, and a dielectric disposed on the resistive material;
2) determining a location of two fingers on the touchpanel;
3) determining the distance between the two fingers;
4) tracking the distance between the two fingers to determine if the fingers are performing a gesture such as pinching, unpinching or rotation.
